(19) United States
(12) Patent Application Publication
(10) Pub. No.: US 2005/0193604 A1
(43) Pub. Date: Sep. 8, 2005

(54) Combination retail display card and display easel

(76) Inventor: Benjamin Fein, Wayne, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/792,184

(22) Filed: Mar. 3, 2004

(51) Int. Cl. G09F 1/00

(52) U.S. Cl. 40/124.17

(57) ABSTRACT

A combination retail display card and display easel. In a retail display configuration, the combination retail display card and display easel is adapted for use with a retail display rack having a support arm. In a display easel configuration, the combination retail display card and display easel is adapted to rest on a supporting surface for displaying a graphic image.

### BACKGROUND OF THE INVENTION

The invention is in the fields of retail packaging and display easels. The invention particularly relates to a device which operates both as a retail display card and as a display easel.

It is known in the prior art to provide retail packages having display cards to which the item being offered for sale is attached. Such display cards are often adapted to be readily mounted on support arms of display racks. It is further known in the art to provide display easels adapted to display graphic images, such as photographs or the like, in a standing position on a shelf or similar supporting surface. It is believed that it would be desirable to combine the functionality of a display card and the functionality of a display easel in a single device.

### BRIEF SUMMARY OF THE INVENTION

Briefly stated, the invention is a combination retail display card and display easel for displaying a graphic image and adapted for use with a retail display rack having a support arm. The combination retail display card and display easel comprises a frame body having a front face and a rear face; an upper end and a lower end; and a first side and a second side. A pre-scored cutout is proximate the upper end, and is sized and shaped to fit the display rack support arm and support the frame body in a retail display configuration. A first member is connected to a remainder of the frame body. The first member has a first position wherein the first member is substantially planar with the remainder of the frame body. The first member also has an second position wherein the first member may be positioned away from the remainder of the frame body such that the first member is positioned to rest on a supporting surface to support the frame body in a display easel configuration. A second member is connected to the remainder of the frame body and has a first position wherein the second member is substantially planar with the remainder of the frame body. The second member also has an second position wherein the second member may be positioned away from the remainder of the frame body and engages the first member such that the second member retains the first member in the first member second position. A graphic image card having the graphic image disposed thereon is affixed to the front face of the frame body.

### BRIEF DESCRIPTION OF THE SEVERAL VIEWS OF THE DRAWINGS

The following detailed description of one preferred embodiment of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a front perspective view of a combination retail display card and display easel in accordance with a preferred embodiment of the present invention, showing the combination retail display card and display easel in a retail display configuration;

FIG. 2 is a front perspective view of the combined retail display card and display easel of FIG. 1, showing the combination retail display card and display easel in a display easel configuration;

FIG. 3 is an exploded perspective view of the combination retail display card and display easel of FIG. 1; and

FIG. 4 is a rear perspective view of the combination retail display card and display easel of FIG. 2.

### DETAILED DESCRIPTION OF THE INVENTION

Certain terminology is used in the following description for convenience only and is not limiting. The words “right”, “left”, “top”, and “bottom” designate directions in the drawings to which reference is made. The words “interior” and “exterior” refer to directions towards and away from, respectively, the geometric center of the combination retail display card and display easel or designated parts thereof. The terminology includes the words above specifically mentioned, derivatives thereof and words of similar meaning.

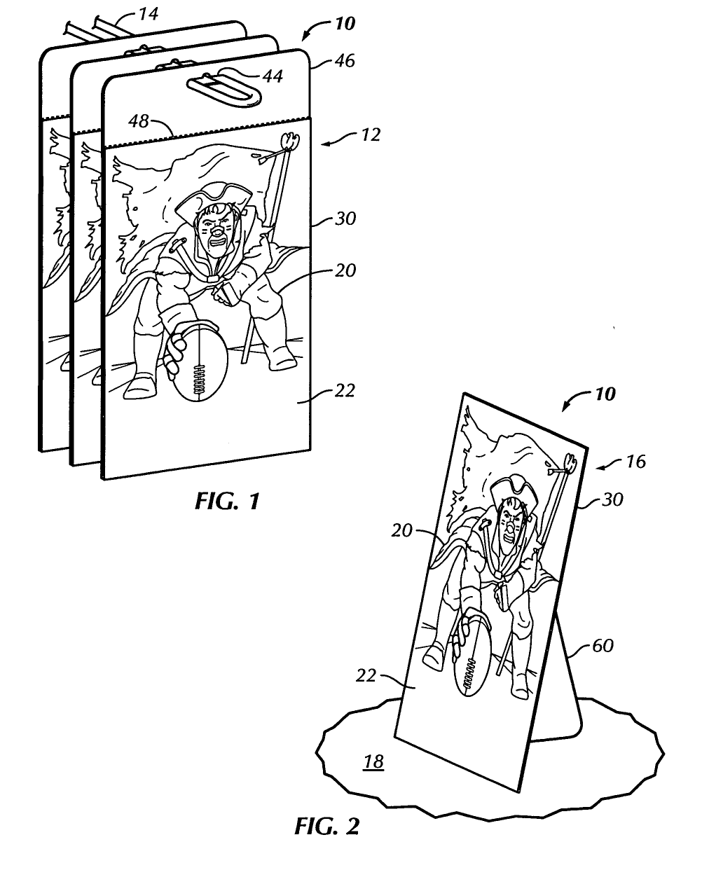

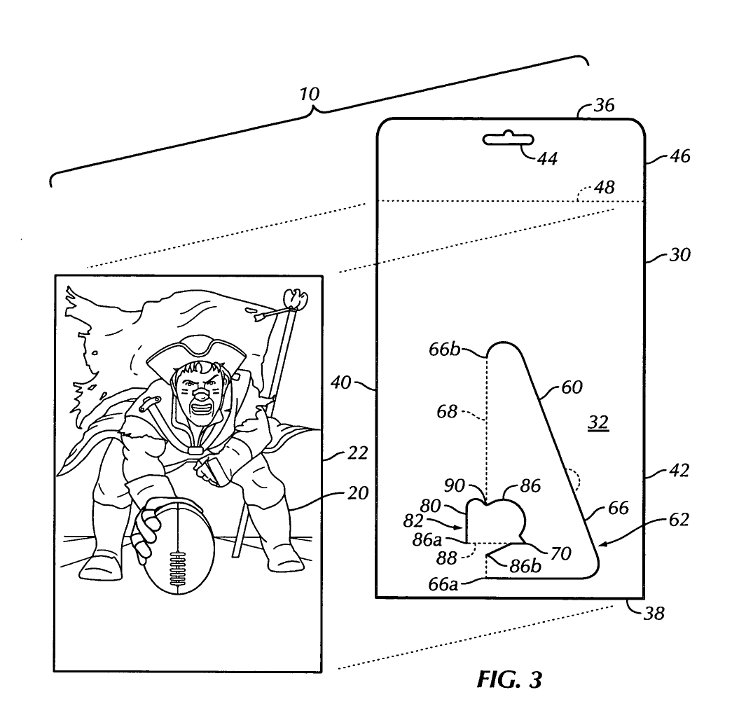

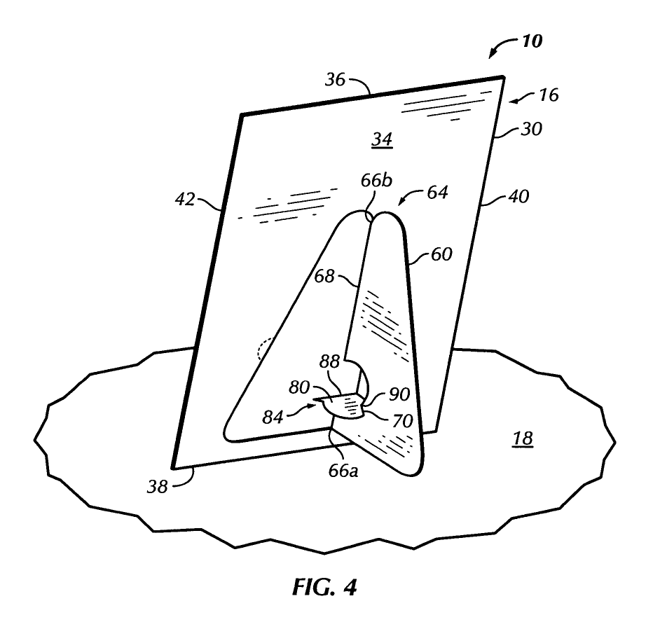

Referring to the drawings, wherein like reference numerals are used to designate the same components throughout the figures, shown in FIGS. 1-4 a combination retail display card and display easel, generally designated 10, for displaying a graphic image 20 and adapted for use with a retail display rack having a support arm 14. The combined retail display card and display easel 10 is shown in a retail display configuration 12 in FIG. 1 and is shown resting on a supporting surface 18 in a display easel configuration 16 in FIGS. 2 and 4.

The combination display card and display easel 10 comprises a graphic image card 22 having the graphic image 20 disposed thereon. Optionally, and in a presently preferred embodiment, the graphic image 20 is produced by a lenticular printing process.

The combination retail display card and display easel 10 further comprises a frame body 30 having a front face 32 and a rear face 34. The graphic image card 22 is affixed to the front face 32 of the frame body 30. The frame body 30 further includes an upper end 36 and a lower end 38 as well as a first side 40 and a second side 42. A pre-scored cutout 44 is provided proximate the upper end 36, and is sized and shaped to fit the display rack support arm 14 to support the frame body 30. Thus, the frame body 30 can be hung from the display rack support arm 14 in the retail display configuration 12.

Preferably, the frame body 30 is formed from a single sheet of material. The material may be, for example, cardboard. Also preferably, the frame body 30 further comprises a detachable display mount portion 46 proximate the upper end 36 and connected to a remainder of the frame body 30 at a score line 48. The score line 48 is preferably a series of perforations allowing the display mount portion 46 to be easily removed from the remaining portion of the frame body 30. Preferably, the display mount portion 46 is removed from the frame body 30 when the combination retail display card and display easel 10 is used in the display easel configuration 16.

A first member 60 is connected to a remainder of the frame body 30 and has a first position 62 wherein the first member 60 is substantially planar with the remainder of the frame body 30. The first member 60 also has an second position 64 wherein the first member may be positioned away from the remainder of the frame body 30 such that the first member 60 may rest on the supporting surface 18 to support the frame body 30 in the display easel configuration 16. The first member 60 is defined by a contoured cut line 66, having a first end 66a and a second end 66b. The first and second ends 66a, 66b define a first member hinge line 68, about which the first member 60 may be rotated into the second position 64. A first member notch 70, operation of which is described herein below, is provided along the first member contoured cut line 66.

A second member 80 is connected to the remainder of the frame body 30 and has a first position 82 wherein the second member 80 is substantially planar with the remainder of the frame body 30 and an second position 84 wherein the second member 80 may be positioned away from the remainder of the frame body 30. The second member 80 is defined by a contour cut line 86, having a first end 86a and a second end 86b. The second member 80 rotates into the second member second position 84 about a second member hinge line 88. The second member contoured cut line 86 includes a second member notch 90. With the first and second members 60, 80 in their respective second positions 64, 84, the second member notch 90 is adapted to releasably engage and interfit with the first member notch 70, so that the first and second members 60, 80 are retained in their respective second positions 64, 84. Alternatively, if the first member 60 were fabricated from a material capable of being readily permanently deformed (for example, a thin sheet of a metallic material such as aluminum), the first member 60 could simply be manually deformed into the second position 64, and the second member 80 would not be required.

In use, the combination retail display card and display easel 10 may be displayed for retail sale in the retail display configuration 12 by installing the frame body 30 on a display rack support arm 14, inserting the display rack support arm 14 through the pre-scored cutout 44. After the consumer purchases the combination retail display card and display easel 10, he or she may proceed to remove the mount portion 46 along the score line 48, and further proceed to move the first and second members 60, 80 into their respective second positions 64, 84, placing the combined retail display card and display easel 10 in the display easel configuration 16. The first and second members 60, 80 are retained in their respective second positions 64, 84, by engagement of the first member notch 70 with the second member notch 90. The combined retail display card and display easel 10 may then be displayed on the supporting surface 18, such as a bookshelf or table.

The artisan will recognize that the display easel 10 could also be used as a wall display frame. Used in this manner, the mount portion 46 would not be removed, and the display easel 10 could be hung from a wall (not illustrated) by a support member (e.g., a nail, not illustrated) inserted through the pre-scored cutout 44.

From the foregoing it can be seen that the present invention comprises a combination retail display card and display easel which combines the functionality of a display card and the functionality of a display easel in a single device.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention.

1. (canceled)

2. (canceled)

3. The combination retail display card and display easel of claim 5 wherein the frame body is formed from a single sheet of material.

4. The combination retail display card and display easel of claim 3 wherein the material is cardboard.

5. A combination retail display card and display easel for displaying a graphic image and adapted for use with a retail display rack having a support arm, the combination retail display card and display easel comprising:
a frame body having:
a front face and a rear face;
an upper end and a lower end;
a first side and a second side;
a pre-scored cutout proximate the upper end, sized and shaped to fit the display rack support arm and support the frame body in a retail display configuration;
a detachable display mount portion proximate the upper end and connected to a remainder of the frame body at a score line;
a first member connected to the remainder of the frame body and having:
a first position wherein the first member is substantially planar with the remainder of the frame body; and
a second position wherein the first member may be positioned away from the remainder of the frame body such that the first member is positioned to rest on a supporting surface to support the frame body in a display easel configuration;
a second member connected to the remainder of the frame body and having:
a first position wherein the second member is substantially planar with the remainder of the frame body; and
a second position wherein the second member may be positioned away from the remainder of the frame body and engages the first member such that the second member retains the first member in the first member second position, and
a graphic image card having the graphic image disposed thereon, wherein the graphic image card is affixed to the front face of the frame body and the graphic image is produced by a lenticular printing process.
